(19) United States
(12) Patent Application Publication
(10) Pub. No.: US 2015/0159824 A1
(43) Pub. Date: Jun. 11, 2015

(54) ASSEMBLIES AND METHODS FOR MOUNTING ELECTRICAL FIXTURES TO SUSPENDED CEILINGS

(71) Applicant: Fluxwerz Illumination Inc., Delta (CA)

(72) Inventors: Mihail Octavian COLAN, Surrey (CA); Lance D. HOWITT, Vancouver (CA); Mark Warren SIEMENS, Coquitlam (CA)

(21) Appl. No.: 14/564,906

(22) Filed: Dec. 9, 2014

Related U.S. Application Data
(60) Provisional application No. 61/914,258, filed on Dec. 10, 2013.

(51) Int. Cl. F21S 8/04; F21S 9/02; F21V 23/00

(52) U.S. Cl. CPC F21S 8/043; F21V 23/008; F21S 9/02; F21V 23/001; F21Y 2101/02

(57) ABSTRACT

An assembly for mounting an electrical fixture to a suspended ceiling is provided. The assembly includes: a bracket comprising an upper portion and a lower portion, the lower portion comprising a clip for securing to a grid member of the suspended ceiling, the upper portion having a flange; a housing for coupling to the flange, the housing having a first enclosure for line voltage circuitry, a second enclosure for at least one driver for the electrical fixture, and a third enclosure for low voltage circuitry. The housing and the bracket are configured to be coupled in an orientation wherein a median plane of the housing is parallel to a median plane of grid member.

### RELATED APPLICATION(S)

This application claims priority to, and incorporates by reference in its entirety, U.S. provisional application No. 61/914,258 filed 10 Dec. 2013.

### TECHNICAL FIELD

This invention relates to assemblies and methods for mounting electrical fixtures to suspended ceilings.

### BACKGROUND

Many building interiors employ suspended ceilings. Suspended ceilings are formed of structural grids and removable ceiling tiles. The components of the structural grids, i.e., grid members, and the removable ceiling tiles can be of various shapes and sizes, and arranged in various configurations. These variations result in numerous on-site variables that may be necessary to consider when installing electrical fixtures to the suspended ceiling. Pre-existing piping, wiring, ductwork and insulation in the plenum space can further complicate the installation process.

Architectural design requirements typically demand mounting electrical fixtures to the suspended ceiling without compromising the structural, acoustic or visual integrity of the suspended ceiling. Predicting on-site mounting conditions can be difficult if not impossible for persons installing electrical fixtures, and hence the conventional requirement for installers to equip themselves with a variety of mounting devices to ensure proper installation.

Assemblies and methods for efficiently mounting electrical fixtures to suspended ceilings are desirable.

### SUMMARY

An aspect of the invention relates to an assembly for mounting an electrical fixture to a suspended ceiling. The assembly comprising: a bracket comprising an upper portion and a lower portion, the lower portion comprising a clip for securing to a grid member of the suspended ceiling, the upper portion comprising a flange; a housing for coupling to the flange, the housing comprising a first enclosure for line voltage circuitry, a second enclosure for at least one driver for the electrical fixture, and a third enclosure for low voltage circuitry, wherein the housing and the bracket are configured to be coupled in an orientation wherein a median plane of the housing is parallel to a median plane of grid member.

The distance between the median plane of the housing and the median plane of the grid member may be less than 25 mm, preferably less than 20 mm, more preferably less than 15 mm, and most preferably less than 10 mm. The width of the housing may be less than 50 mm, preferably less than 40 mm, more preferably less than 30 mm, and most preferably less than 20 mm. The distance between the median plane of the housing and the median plane of the grid member, and/or the width of the housing, may be limited to allow an unobstructed path for ceiling tiles supported by the grid member to be lifted up to facilitate access to a plenum space.

The first enclosure may be adjacent to and separated from the second enclosure by a first wall, and the first enclosure may be adjacent to and separated from third enclosure by a second wall. The first wall may comprise a first aperture and a second aperture, and the second wall may comprise a third aperture, whereby an electrical conduit between the line voltage circuitry and the driver extends through the first aperture, and an electrical conduit between the driver and the low voltage circuitry may extend through the second and third apertures.

The at least one driver may comprise a plurality of drivers. The housing and the bracket may be configured such that the housing is oriented vertically or horizontally. The flange of the upper portion of the bracket may comprise tabs for coupling with corresponding slots on the housing. The housing may comprise a fourth enclosure for backup batteries.

The assembly may comprise a upper wire retaining element and a lower wire retaining element for securing a ceiling wire to secure the housing to a building structure. The upper wire retaining element may comprise an aperture in the upper portion of the bracket, and the lower wire retaining element may comprise a slot in an upper bracket, wherein the upper bracket is secured to an upper portion of the housing.

The electrical fixture may be an LED luminaire. The LED luminaire may be a suspended LED luminaire.

The foregoing discussion merely summarizes certain aspects of the inventions and is not intended, nor should it be construed, as limiting the inventions in any way.

### BRIEF DESCRIPTION OF THE DRAWINGS

In drawings which show non-limiting embodiments of the invention:

FIG. 1 is a cross-sectional schematic view of an assembly according to an embodiment of the invention;

FIG. 2 is an isometric view of the assembly according to the embodiment of FIG. 1 exposing the interior of the assembly (without circuitry);

FIG. 3 is an isometric view of the assembly according to the embodiment of FIG. 1;

FIG. 4 is an isometric view of the assembly according to the embodiment of FIG. 1;

FIG. 5 is a close-up isometric view of the top portion of the assembly according to the embodiment of FIG. 1;

FIG. 6 is a close-up isometric view of the bottom portion of the assembly according to the embodiment of FIG. 1;

FIG. 7 is an isometric view of an assembly according to an embodiment of the invention exposing the interior of the assembly (without circuitry);

FIG. 8 is an isometric view of an assembly according to an embodiment of the invention exposing the interior of the assembly (without circuitry); and

FIGS. 9A to 9D are isometric views of a bracket according to an embodiment of the invention in various states of assembly.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The term “electrical fixture” as used herein refers to electrical fixtures typically mounted to a ceiling for electrical connection, and includes lighting fixtures, video surveillance cameras, fans, hardwired smoke and/or carbon monoxide detectors, audio/visual components, and the like.

The term “T-bar” as used herein refers to any rigid elongated member forming part of a structural grid of a suspended ceiling. T-bars may for example have an inverted “T” cross-sectional profile. Other examples of T-bars may have an “L”, “H”, “I”, or “Z” cross-sectional profile.

The term “T-bar hanger” as used herein refers to any rigid elongated member configured to span between spaced parallel T-bars of a structural gird of a suspended ceiling. The CADDY® T-Grid Box Hanger is an example of a T-bar hanger.

The term “grid member” as used herein refers to a T-bar or a T-bar hanger.

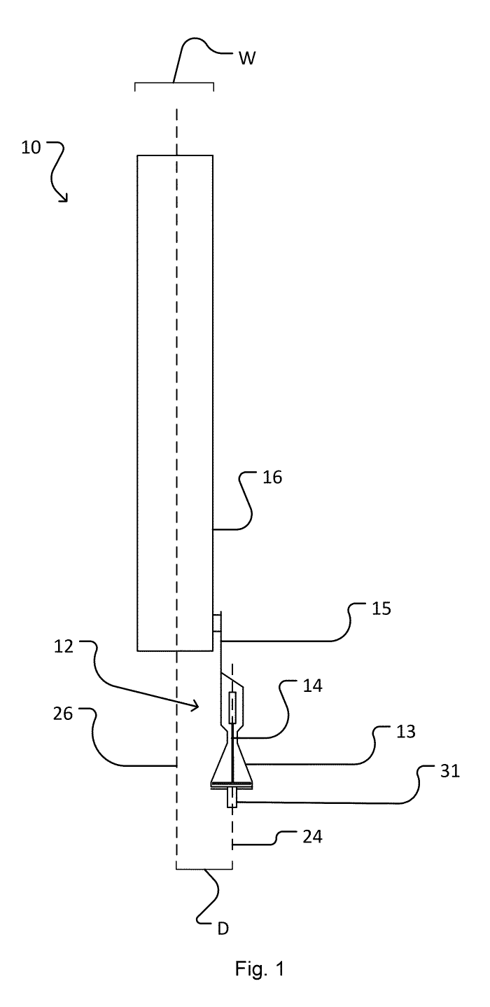

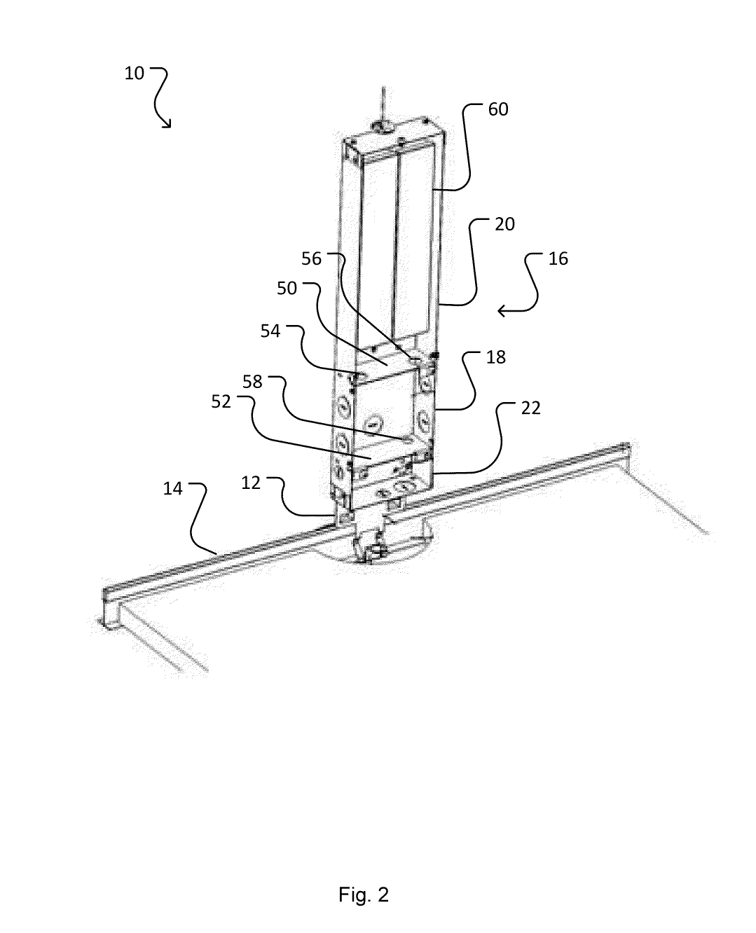

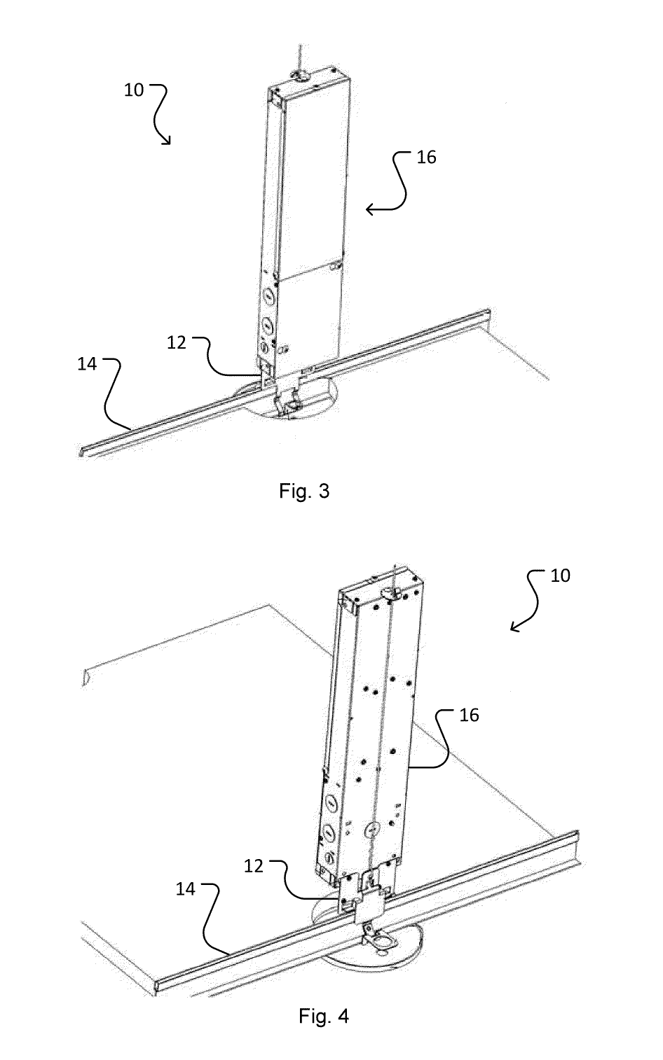

FIGS. 1 to 6 illustrate an assembly 10 according to an embodiment for mounting an electrical fixture to a suspended ceiling. Assembly 10 has a bracket 12 for securing to a grid member 14 of the suspended ceiling. Grid member 14 is a T-bar in this embodiment. Bracket 12 couples to housing 16, which includes a first enclosure 18 for line voltage circuitry, a second enclosure 20 for at least one driver 60 for the electrical fixture, and a third enclosure 22 for low voltage circuitry. Some embodiments may have different numbers and/or configurations of enclosures and circuits/drivers.

In embodiments where drivers are required by the electrical fixture, such as LED luminaires, physically separating the drivers from the fixture and concealing it above a suspended ceiling in accordance with the invention permits greater freedom in fixture design (e g minimizing the size of an LED luminaire) by removing the requirement to incorporate the relatively bulky drivers into the fixture itself.

A first wall 50 separates first enclosure 18 and second enclosure 20, and a second wall 52 separates first enclosure 18 and third enclosure 22. First wall 50 includes aperture 54 through which an electrical conduit between the line voltage circuitry and driver 60 extends. First wall 50 also includes aperture 56, and second wall 52 includes aperture 58. An electrical conduit between driver 60 and the low voltage circuitry extends through apertures 56 and 58. Line voltage may for example be 120V, 277V or 347V. Low voltage may for example be less than 36 V.

In some embodiments, such as the embodiments shown in the FIG. 1, bracket 12 comprises a clip 13 formed at a lower portion of bracket 12, and a flange 15 formed at an upper portion of bracket 12.

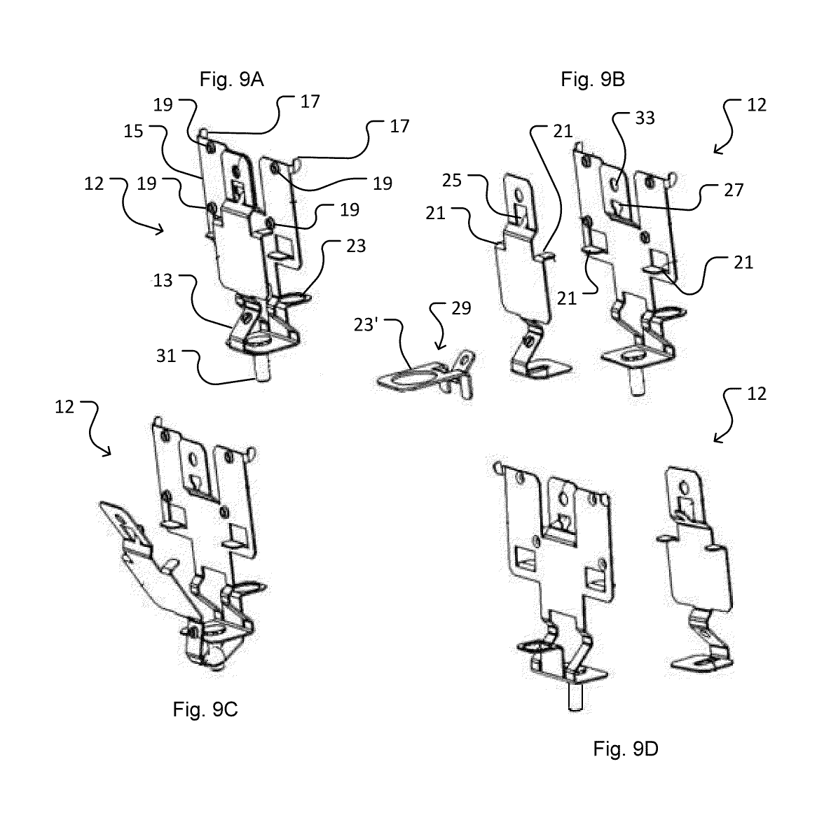

Clip 13 is configured to be secured to grid member 14. As shown in FIGS. 9A to 9D, clip 13 may generally comprise a two-piece assembly that clamps around grid member 14 and is secured together by any suitable means, such as by snapping together at tab 25 and corresponding slot 27. Tabs 21 may be used to facilitate securing bracket 12 to grid member 14. Clip 13 may be any suitable universal clip that receives different shapes and sizes of T-bars and T-bar hangers.

Flange 15 includes tabs 17 receivable in corresponding slots of housing 16 to facilitate mounting of housing 16. Flange 15 may be fastened to a lower portion of housing 16 by suitable means, such as mechanical couplings 19.

In some embodiments, bracket 12 may be any other suitable bracket having a lower portion for securing to grid member 14 and an upper portion for fastening to housing 16 in the positions and orientations described herein. In embodiments such as those illustrated, the universal bracket and the housing are formed independently to permit different housings (for example with different internal configurations and/or components) to be used with the same universal bracket.

Aperture 23 of bracket 12 and/or aperture 23′ of optional bracket element 29 guide low voltage electrical conduits from the low voltage circuitry of third enclosure 22 to the electrical fixture, such as an LED luminaire. Bracket 12 also includes a stud 31 or other suitable attachment means for coupling to the hardware kit of the electrical fixture. The hardware kit may for example include a canopy 38 and one or more electrical conduit sleeves (not shown). Canopy 38 conceals any exposed part of bracket 12. Stud 31 or other suitable attachment means also support the weight bearing load of the electrical fixture. For example, where the electrical fixture is an LED luminaire, bracket 12 through stud 31 can support an aircraft cable mount to suspend the luminaire.

According to some embodiments, such as in the embodiments illustrated herein, housing 16 has shape of a generally elongated thin rectangular box. In some embodiments, housing 16 may be of other generally narrow three dimensional shapes. According to example embodiments, the width W of housing 16 is less than 50 mm, or less than 40 mm, or less than 30 mm, or less than 20 mm.

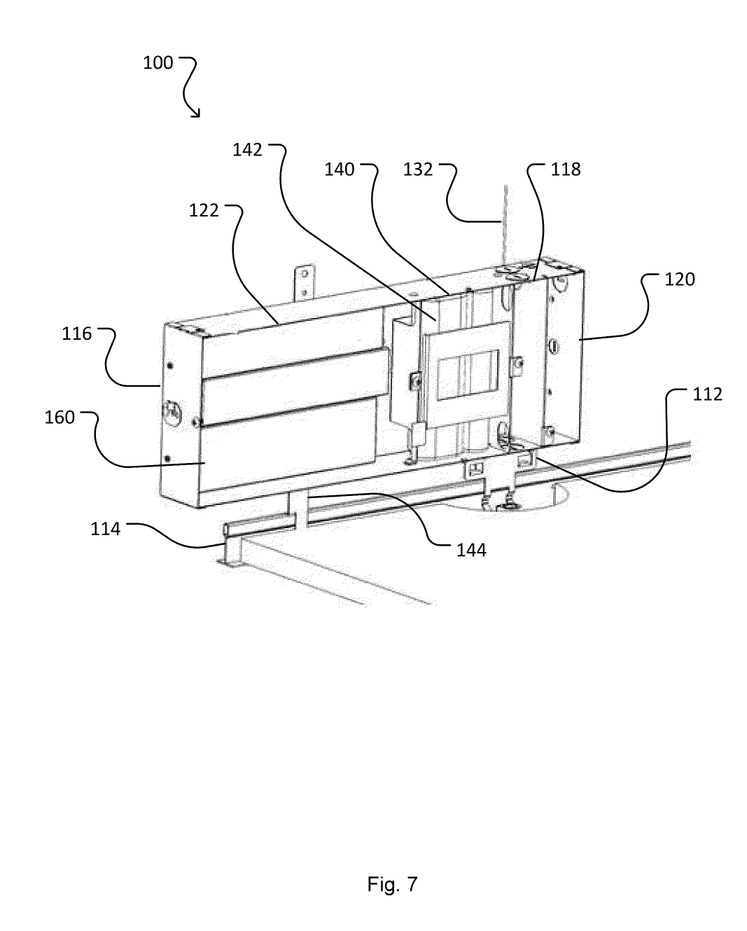

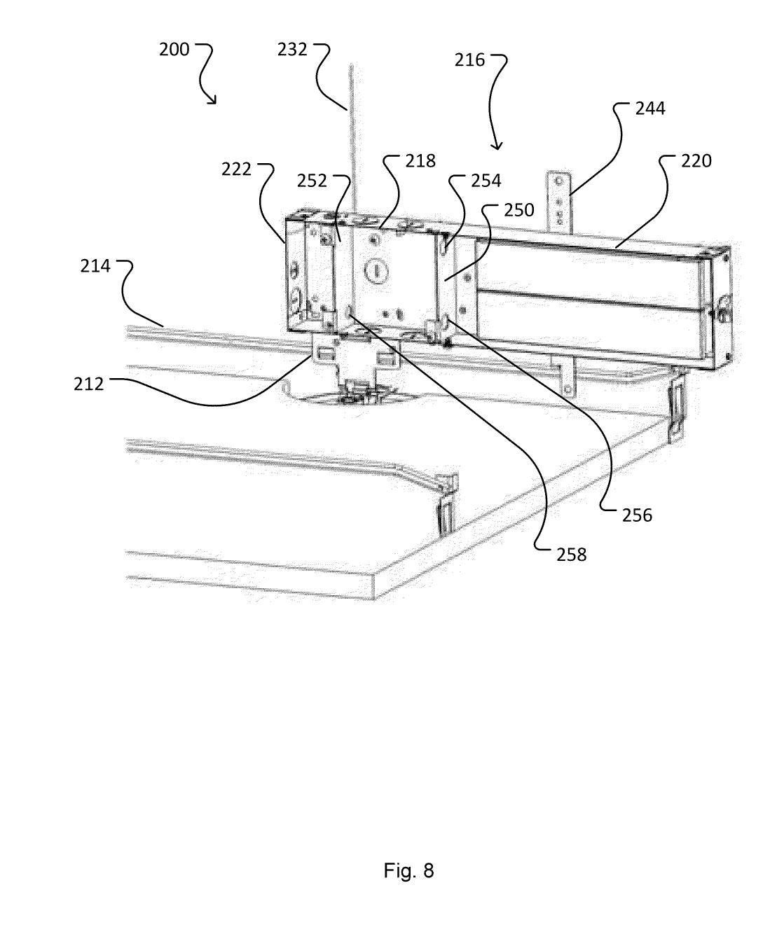

The housing can be coupled to the bracket in a vertical orientation, as shown in in the embodiment of FIGS. 1 to 6, or in a horizontal orientation, as shown in the embodiments in FIGS. 7 and 8. In both orientations, the narrowest dimension (i.e., the width, W) of the housing is transverse to the long axis of the grid member. In other words, a median plane 26 of housing 16 is parallel to a median plane 24 of grid member 14, where median plane 26 is defined as the plane vertically bisecting housing 14 and parallel to the planes of the two largest opposing surfaces of housing 16, and median plane 24 is defined as the plane vertically bisecting grid member 14 along the long axis of grid member 14.

According to example embodiments, the distance D between median plane 26 of the housing 16 and median plane 24 of grid member 14 is less than 25 mm, or less than 20 mm, or less than 15 mm, or less than 10 mm. In some embodiments, median plane 26 of the housing 16 and median plane 24 of grid member 14 may be identical, and therefore distance D is zero. Minimizing or eliminating the horizontal offset of the housing relative to the bracket, and in turn relative to the grid member, according to the invention, provides advantages including (i) maintaining as much of the center of gravity of the housing over the grid member as possible and (ii) in combination with the narrow width W and orientation of the housing, allows unobstructed path for ceiling tiles supported by the grid member to be lifted up to facilitate access to the plenum space.

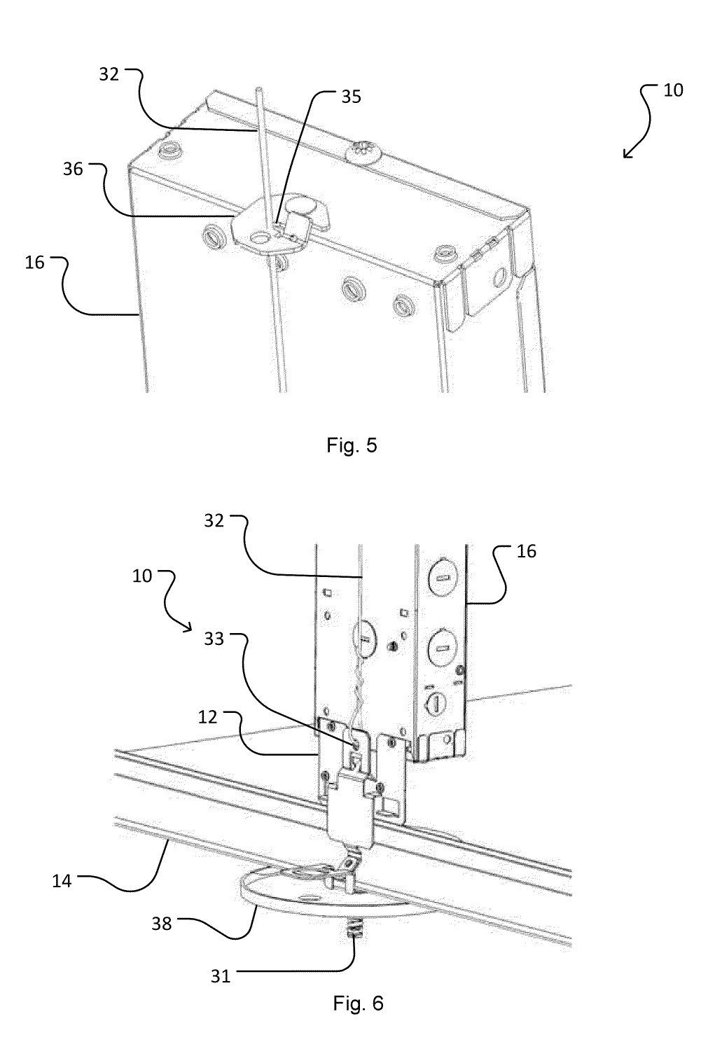

In some embodiments, housing 16 may be further supported by a ceiling wire 32 or other support feature attached to a building structure. The building structure may for example be a ceiling joist or permanent ceiling. In some embodiments, ceiling wire 32 is secured to two or more vertically spaced apart locations along assembly 10, such as a lower wire retaining element and an upper wire retaining element, and then attached to the building structure. The lower wire retaining element may be a suitable element of bracket 12 and the upper wire retaining element may be a suitable element of a support bracket 36 secured to an upper portion of housing 16. For example, as shown in FIGS. 5 and 6, ceiling wire 32 may be secured to an aperture 33 in the upper portion of bracket 12, and then guided through a slot 35 of support bracket 36, and then attached to the building structure. In some embodiments, support bracket 36 may also have a bendable tab 37 that can be manually bent to close off the entrance to slot 35 to ensure ceiling wire 32 is retained in slot 35.

FIG. 7 shows assembly 100 according to an alternative embodiment. Like numbered elements in FIG. 7 and FIGS. 1 to 6 refer to similar elements having similar functions. Grid member 114 is a T-bar. Assembly 100 is oriented horizontally, in contrast to the vertical orientation of assembly 10. Bracket 144 secured to grid member 114 and housing 116 provides additional support for housing 116. Housing 116 additionally includes a backup battery enclosure 140 containing backup batteries 140 to supply power to the electrical fixture during power failures or other emergency conditions. In some embodiments, integration of rechargeable emergency battery power in housing 16 permits a test light indicator and a test switch to be connected at third enclosure 22 and integrated into canopy 38 so as to be visible from below the ceiling.

FIG. 8 shows assembly 200 according to an alternative embodiment. Like numbered elements in FIG. 8 and FIGS. 1 to 6 refer to similar elements. Grid member 214 is a T-bar hanger. Assembly 200 is oriented horizontally, in contrast to the vertical orientation of assembly 10. Bracket 244 secured to grid member 214 and housing 216 provides additional support for housing 216.

This application is intended to cover any variations, uses, or adaptations of the invention using its general principles. Further, this application is intended to cover such departures from the present disclosure as come within known or customary practice in the art to which this invention pertains and which fall within the limits of the appended claims. Accordingly, the scope of the claims should not be limited by the preferred embodiments set forth in the description, but should be given the broadest interpretation consistent with the description as a whole.

1. An assembly for mounting an electrical fixture to a suspended ceiling, the assembly comprising:
a bracket comprising an upper portion and a lower portion, the lower portion comprising a clip for securing to a grid member of the suspended ceiling, the upper portion comprising a flange;
a housing for coupling to the flange, the housing comprising:
a first enclosure for line voltage circuitry;
a second enclosure for at least one driver for the electrical fixture; and
a third enclosure for low voltage circuitry;
wherein the housing and the bracket are configured to be coupled in an orientation wherein a median plane of the housing is parallel to a median plane of grid member.

2. An assembly according to claim 1, wherein a distance between the median plane of the housing and the median plane of the grid member is less than 25 mm, preferably less than 20 mm, more preferably less than 15 mm, and most preferably less than 10 mm.

3. An assembly according to claim 1, wherein a width of the housing is less than 50 mm, preferably less than 40 mm, more preferably less than 30 mm, and most preferably less than 20 mm.

4. An assembly according to claim 1 wherein the distance between the median plane of the housing and the median plane of the grid member, and/or the width of the housing, are limited to allow an unobstructed path for ceiling tiles supported by the grid member to be lifted up to facilitate access to a plenum space.

5. An assembly according to claim 1 wherein the first enclosure is adjacent to and separated from the second enclosure by a first wall, and the first enclosure is adjacent to and separated from third enclosure by a second wall.

6. An assembly according to claim 5 wherein the first wall comprises a first aperture and a second aperture, and the second wall comprises a third aperture, whereby an electrical conduit between the line voltage circuitry and the driver extends through the first aperture, and an electrical conduit between the driver and the low voltage circuitry extends through the second and third apertures.

7. An assembly according to claim 1, wherein the at least one driver comprises a plurality of drivers.

8. An assembly according to claim 1, wherein the housing and the bracket are configured such that the housing is oriented vertically or horizontally.

9. An assembly according to claim 1, wherein the flange comprises tabs for coupling with corresponding slots on the housing.

10. An assembly according to claim 1 wherein the housing comprises a fourth enclosure for backup batteries.

11. An assembly according to claim 1 comprising an upper wire retaining element and a lower wire retaining element for securing a ceiling wire to secure the housing to a building structure.

12. An assembly according to claim 11 wherein the upper wire retaining element comprises an aperture in the upper portion of the bracket, and the lower wire retaining element comprises a slot in an upper bracket, wherein the upper bracket is secured to an upper portion of the housing.

13. An assembly according to claim 1 wherein the electrical fixture is an LED luminaire.

14. An assembly according to claim 13 wherein the LED luminaire is a suspended LED luminaire.
